(19) United States
(12) Patent Application Publication
(10) Pub. No.: US 2014/0260553 A1
(43) Pub. Date: Sep. 18, 2014

(54) DETECTION DEVICE FOR DETECTING AT LEAST ONE FAULT STATE

(71) Applicant: Astrium GmbH, Taufkirchen (DE)

(72) Inventors: Peter KERN, Salem (DE); Ulrich KUEBLER, Markdorf (DE); Thomas HUMMEL, Salem (DE)

(73) Assignee: Astrium GmbH, Taufkirchen (DE)

(21) Appl. No.: 14/198,849

(22) Filed: Mar. 6, 2014

(30) Foreign Application Priority Data
Mar. 15, 2013 (EP) 13159570

(51) Int. Cl. G01M 3/20

(52) U.S. Cl. CPC G01M 3/20
USPC 73/40.7

(57) ABSTRACT

Detection device for detecting at least one fault state includes at least one tracer unit that includes, in at least one operating state, at least one specifically added tracer substance, and at least one detection unit for detecting a portion of material that has been released from the at least one tracer substance.

### PRIOR ART

The invention relates to a detection device for detecting at least one fault state, said detection device having at least one tracer unit that comprises, in at least one operating state, at least one specifically added tracer substance, and having at least one detection unit for detecting a portion of material that has been released from the at least one tracer substance.

Detection devices according to the prior art, which are provided for detecting a fault state, by way of example for detecting wire fires or an overload pressure inside a device and/or an assembly part, based on the principle of detecting the products that are generated as a result of the fault state, by way of example by detecting the molecules of a synthetic material that are released from wire insulation as a result of charred wire insulation. In the event of an overload pressure, a tracer substance is released as a result of damage to a mechanical casing or to an embedded arrangement. Consequently, it is only possible to state the fault state once it has occurred.

The objective of the invention is to provide in particular a detection device that renders it possible to detect at least one fault state and that preferably renders it possible to detect the at least one fault state prior to further damage or danger being caused as a result of the fault state.

### ADVANTAGES OF THE INVENTION

The invention describes a detection device for detecting at least one fault state, said detection device having at least one tracer unit that comprises, in at least one operating state, at least one specifically added tracer substance, and having at least one detection unit for detecting a portion of material that has been released from at least one tracer substance.

The term “fault state” is to be understood to mean in particular a state that differs from a safe operating state, wherein particularly in the fault state conditions prevail that differ at least essentially from the conditions that occur in the safe operating state, by way of example a state in which the temperature has greatly increased, in particular the temperature of current-conducting assembly parts, by way of example a wire or a wire harness, or a state in which the pressure in a vessel and/or line has increased, or a state in which there is a loss of atmosphere, in particular under conditions of reduced gravity, by way of example in outer space. It is preferred that the at least one fault state that is to be detected is selected in such a manner that the at least one fault state occurs prior to a state that endangers people, and that, in particular in the case of the at least one fault state occurring, it is still possible to avoid people being endangered.

The term “tracer unit” is to be understood to mean in particular a unit that, in at least one operating state, comprises at least one specifically added tracer substance that is provided in particular for the purpose of being released in at least one operating state, wherein in particular a quantity of material of the at least one tracer substance that is released per unit of time in the at least one fault state is at least 10%, advantageously at least 50% and preferably at least 100% more than a quantity of the at least one tracer substance that is released per time unit in the safe operating state or at least 10%, advantageously at least 50% and advantageously 100% less than a quantity of the at least one tracer substance that is released per time unit in the safe operating state. The expression that the at least one tracer substance “is provided for the purpose of being released in at least one operating state” is to be understood to mean in particular that the at least one tracer substance is especially selected and/or especially arranged, by way of example especially provided and/or introduced, so that in the at least one operating state portions of the material of the at least one tracer substance are released into an environment, in particular into an at least in part gas-filled environment or into a surrounding vacuum. It is preferred that individual molecules of the at least one tracer substance change into a gas phase and by way of a random movement of the molecules in the at least in part gas-filled environment and/or by means of a naturally and/or artificially purposefully generated gas flow arrive at a location of the least one detection unit. The expression “in at least one operating state comprise the at least one tracer substance” is to be understood in particular to mean that the tracer unit has a store of the at least one tracer substance and said store is no longer available once said tracer substance has been completely dispensed. The term “specifically added tracer substance” is to be understood to mean in particular a substance that in addition to a material of an assembly part is arranged on a surface of the assembly part or on a casing or on a packaging of the assembly part and/or in and/or on the assembly part, the casing or the packaging of the assembly part, and that comprises in particular in comparison to an environment a vapor pressure that is at least 0.1% or 10%, advantageously at least 50% and preferably at least 100% greater than a vapor pressure of materials of the assembly part or an environment of the assembly part and that has been selected with reference to the at least one detection unit to such an extent that the at least one detection unit detects the presence of at least one tracer substance in the environment even where the concentration of said tracer substance is low. In particular, the at least one tracer substance is preferably different to materials that are discharged during a hazardous event and are in particular damaging to health, such materials being for example gases that are given off in the event of a fire and/or aerosol particles such as for example smoke particles that are given off by wire insulation that is disintegrating as a result of a wire fire. In particular, the at least one tracer substance is not dangerous for humans even in concentrations resulting from a complete discharge of an entire material quantity that is present in the tracer unit is completely discharged in the resultant concentrations. The tracer substance can be formed by way of example from organic substances, such as for example alcohols, ketones, fragrant substances, aromatic substances, and/or from inorganic substances, such as for example ammonia or hydrogen sulfide. In particular, the tracer substance is specifically selected and/or is provided in a specifically treated form so that, in the event of the environmental conditions changing into a fault state, said tracer substance is released and is detected by the detection unit prior to the fault state occurring, by way of example in that said tracer substance is released, when a wire heats up, in the event of a temperature limit being exceeded prior to a smoldering combustion of wire insulation, or in the event of a small pressure reduction or in the event of a pressure increase in the assembly part that is to be monitored. It is preferred that molecules of the at least one tracer substance have a small molecular size so that they can diffuse through a material in which the molecules of the tracer substance are introduced or can easily escape from small areas where the material has been mechanically damaged. The term “detection unit” is to be understood to mean a unit having at least one detection element for detecting the at least one tracer substance that in particular when detecting that a predetermined limit concentration of the at least one tracer substance has been exceeded emits a signal, preferably an electrical, electronic, mechanical, visual or acoustic signal. Fundamentally, different detection principles can be used for a detection process by means of which the detection unit detects the at least one tracer substance, different detection principles being by way of example optical absorptiometry, gas chromatography, gas chromatography with mass spectrometry coupled thereto, infra-red spectroscopy, Fourier transformation infra-red spectroscopy, ion mobility spectrometry, ionization detection, a method in which oscillation properties and/or a capacity and/or a conductance value of a sensor is changed by means of the at least one tracer substance, by way of example in the case of a metal oxide sensor. The preferably electronic signal can be transmitted fundamentally by way of a wire and/or in a wireless manner. Fundamentally, the detection unit can also comprise a multiplicity of detection elements that are provided for detecting the at last one tracer substance or for detecting different tracer substances, wherein fundamentally it is also possible, in place of outputting a signal in the event of a predefined limit concentration being exceeded, also to output a signal in the event of a pattern of multiple measurement signals being identified. It particular, it is possible to detect at least one fault state prior to a hazard occurring as a result of the at least one fault state.

In a further embodiment of the invention, it is proposed that the at least one tracer unit comprises at least one carrier element at which and/or in which and/or on which the at least one tracer substance is arranged. The expression that “the at least one tracer substance is arranged at and/or in and/or on the at least one carrier element” is to be understood to mean in particular that the at least one tracer substance is arranged at least on a surface of the carrier element and/or in a material of the carrier element, wherein the at least one tracer substance can in principle cover an entire surface and/or can be mixed into a total material of the carrier element and/or can merely be applied in sections and/or can be mixed in and/or introduced in sections. In particular, the at least one tracer substance can be applied during a production process to the at least one surface of the carrier element and/or can be arranged on said surface during the process of producing the surface of the carrier element. In particular, the at least one tracer substance can be mixed in a material of the at least one carrier element during a process of producing the at least one carrier element and/or subsequently introduced, wherein the carrier element can comprise hollow spaces that are provided especially for receiving the at least one tracer substance or said carrier element can comprise a porous structure into which the at least one tracer substance can be bound and/or introduced. The carrier element can by way of example also be embodied as a coating on at least one surface of an assembly part, as a separate element that is arranged on an assembly element of the assembly unit, by way of example on a transformer, on a current-conducting wire or on a medical unit and/or on a medical device, such as a magnetic resistance tomography device, said separate element being by way of example a sticker that is fastened to the assembly element, as an element that is integrated in an assembly unit and/or as an element that is mixed into a material of the at least one assembly element of the assembly unit. The term “assembly unit” is to be understood to mean in particular at least a unit having at least one assembly element, such as in particular for example a device that heats up as a result of resistive heating during operation, by way of example a computer or an air-conditioning system or a medical device such as for example a magnetic resistance tomography device or an X-ray device, and/or a functional assembly part such as for example current-conducting wires, transformers and/or electrical and/or pressurized equipment, a surface of a device such as for example a cover of a computer or a cover of a medical device, a surface of a functional assembly part, another device such as for example a laboratory bench or a surface of walls that define a space, wherein preferably an increased risk of fire, as a result of the operated instruments and/or stored material, exists in the space that is defined by the walls and/or said space is exposed to special environmental conditions, by way of example a surrounding air-free space in the case of space travel. In particular, the at least one assembly unit can be formed by way of example by a surface towards which a laser being operated in an experiment may be directed in the case of an incorrect alignment and which surface could be damaged by the laser. The at least one tracer substance can be applied and/or bound in a pure form to and/or in the at least one carrier element, or said tracer substance can be bound in a bound form by way of example to an adsorbent material, received in a solution and/or in a micelle and/or introduced in a micro-capsule and/or applied and/or bound in and/or on the carrier element. In the case of the at least one tracer substance being bound in a material of the at least one carrier element, the tracer substance is provided for the purpose of diffusing through the material of the at least one carrier element or said tracer substance is released as a result of mechanical damage to a casing. The term “provided” is to be understood to mean especially selected, designed and/or equipped. The expression that a substance is provided for a specific function is to be understood to mean in particular that the substance is selected to the effect that said substance fulfills and/or performs this specific function in at least one application state and/or operating state. In particular, it is possible to purposefully introduce the at least one tracer substance, preferably at particularly endangered locations.

Furthermore, it is proposed that the carrier element comprises at least one adsorbent material. The term an “adsorbent material” is to be understood to mean in particular a material that is provided for the purpose of adsorbing the at least one carrier substance on a surface and/or in material pores, in particular on surfaces of material walls that are defining material pores or in other hollow spaces. The adsorbent material can be by way of example activated charcoal, nano materials such as carbon nanotubes, stationary phases from the field of gas chromatography or gas purification, micro-capsules, micelle and/or an adsorbent resin. The at least one tracer substance can be absorbed on and/or by the adsorbent material during a process of producing the adsorbent material and/or can be introduced into the adsorbent material for adsorption purposes during and/or subsequently to the production process. It is possible in particular to apply the at least one tracer substance safely and reliably and to ensure in particular that a large quantity of said tracer substance is not released during normal operating conditions.

It is proposed that the at least one tracer unit comprises at least one coating with the at least one tracer substance. The coating can contain the at least one tracer substance in a pure form and/or in a bonded form. In particular, the at least one coating can be applied, subsequently to producing at least one assembly unit, in any position afterwards, in particular in endangered positions. It is preferred that the coating is arranged on a surface of the at least one carrier element and/or the at least one assembly unit, said surface being open to the environment, so that released portions of material of the at least one tracer substance can pass directly to the at least one detection unit. In particular, the at least one tracer unit can be applied in a rapid and safe and reliable manner.

Moreover, it is proposed that the at least one tracer unit is embodied at least in part in one piece with at least one assembly unit. The expression that “the at least one tracer unit is embodied at least in part in one piece with at least one assembly unit” is to be understood to mean that the at least one tracer unit and the at least one assembly unit comprise at least one common element. In particular, the at least one tracer substance can be applied to at least one assembly element of the at least one assembly unit in particular directly, by way of example by means of a continuous, section-by-section or spot-by-spot coating method, and/or can be worked into a material at least of one assembly element of the at least one assembly unit and/or can be introduced into the at least one assembly element during a process of producing the at least one assembly element and/or the material of the at least one assembly element. In particular, it is possible to make direct contact with particularly endangered locations and/or locations that require separate protection and it is not necessary to provide a separate assembly part for the at least one tracer unit.

Furthermore, it is proposed that the at least one fault state is an inadmissible temperature change of at least one assembly unit. The term “inadmissible temperature change” is to be understood to mean a temperature change, preferably a temperature increase of at least one assembly element of the at least one assembly unit, due to which a temperature of the at least one assembly unit departs from a previously defined temperature range that is to be expected during normal operation. It is preferred that the inadmissible temperature change is selected to the effect that, when detecting released portions of material of the at least one tracer substance, there is a high level of probability that the at least one assembly unit remains undamaged. In particular, an inadmissible temperature increase of the at least one assembly unit is less than a temperature increase of the at least one assembly unit that leads to the at least one assembly unit being damaged as a result of the material disintegrating and/or a fire. In particular, it is possible to detect a risk of fire and thus to increase safety.

Furthermore, it is proposed that the inadmissible temperature change is given by the temperature exceeding a predetermined temperature limit below a damage-producing temperature of the at least one assembly unit. In particular, it is possible to detect a risk of fire prior to a fire breaking out and thus to increase safety.

Moreover, it is proposed that the at least one fault state is a change in pressure. The term “change in pressure” is to be understood to mean that a previously defined limit value of an air pressure and/or gas pressure is not achieved or is exceeded. Pressure reductions represent a high risk, particularly under extensive vacuum conditions, by way of example on board a space ship, since pressure reductions are associated with a loss of life-essential atmosphere gases that are present to a limited extent, and moreover pressure reductions can cause structural damage. In particular, it is possible to increase safety.

Furthermore, it is proposed that the at least one tracer unit comprises, in at least one operating state, at least one specifically added further tracer substance. Fundamentally, the at least one tracer substance and the at least one further tracer substance can be mixed one with the other or can be present separately from one another. In particular, the detection unit can comprise a detection element for detecting the at least one tracer substance and a detector element for detecting the at least one further tracer substance so that even in the event of the detection element for the at least one tracer substance failing, it is still possible for the at least one fault state to be detected by detecting the at least one further tracer substance. It is also possible to provide the at least one further tracer substance for detecting a further fault stage so that at least two fault states can be detected by means of the at least one tracer unit. Fundamentally, the at least one tracer substance and the at least one further tracer substance can be provided for detecting the same fault stage at different sites. In particular, it is possible to increase the detection probability and the safety and reliability of the detection process and/or to detect different fault states and also in particular in addition to locate the site of the fault state.

Moreover, it is proposed that the at least one tracer substance and the at least one further tracer substance are arranged at least in part at and/or on different assembly units and/or different assembly elements of at least one assembly unit. In particular, it is possible to make it easier to locate the site of a source of the fault state.

Furthermore, it is proposed that the at least one detection unit is provided for the purpose of detecting the at least one fault state by means of recognizing a pattern of signals of the at least one tracer substance and the at least one further tracer substance. In particular, the at least one detection unit can detect a fault state by means of recognizing a pattern of signals of a multiplicity of tracer substances, by way of example eight tracer substances. Fundamentally, the detection unit can also be embodied for the purpose of detecting at least one fault state by means of recognizing a pattern of signals from fewer or more than eight tracer substances. In particular, it is possible by means of detecting a specific signal of multiple tracer substances to detect at least one fault state in a safe and reliable manner even in the presence of a gas mixture of a multiplicity of chemically similar materials to which the detection elements of the at least one detection unit react.

Furthermore, it is proposed that the at least one detection unit is provided for detecting a reduction and/or an interruption in the release of the at least one tracer substance. This represents an inverse mode to that of the conventional method of detecting a chemical substance that occurs during at least one fault state. In particular, the at least one tracer substance is provided for the purpose of being released under normal conditions in a quantity that causes a considerable signal change of the at least one detection unit and in the event of a fault state occurring for the purpose of being released in a significantly smaller quantity, by way of example in that an inadmissible temperature increase causes an essentially volatile tracer substance to bond in an essentially non-volatile manner with a material on which the tracer substance is applied and/or introduced. In particular, it is possible to increase safety.

Furthermore, it is proposed that the at least one detection unit comprises at least one data interface that is provided for transmitting a detected fault state to a superior monitoring system. The term “superior monitoring system” is to be understood to mean in particular a monitoring system that monitors at least an assembly unit, a device and/or a space and advantageously a plurality of assembly parts, devices and/or spaces by means of a detection device and, by means of at least one output device, indicates at least visually, optically and/or acoustically a fault state that has been detected by means of at least one detection device. It is preferred that the superior monitoring system comprises at least one storage unit in which at least information regarding the fault state is stored together with further additional information such as for example the time and site of the fault state. In particular, it is possible to increase safety.

Furthermore, it is proposed that the at least one detection unit comprises at least one signal unit that is provided for the purpose of signaling a detected fault state. The term “signal unit” is to be understood to mean a unit that is provided for the purpose of outputting an acoustic, visual, electrical and/or mechanical signal, and that for the purpose of outputting a signal comprises a signal device, such as by way of example a siren, a loud speaker, a bell, a warning light, a mechanical or electronic display board, an indicator plate that can be folded open mechanically and/or a screen. It is preferred that the signal unit is arranged in a space that is monitored by the detection unit and/or in the proximity of an assembly part that is monitored by the detection unit. Fundamentally, the detection device can comprise a storage unit in which at least information regarding the fault state is stored together with further additional information such as for example the time and site of the fault state. Attention can be drawn in particular with a high level of safety and reliability to at least one potential and/or impending hazardous state.

Furthermore, a method is proposed for detecting a fault state, with a detection device in accordance with the invention.

### DRAWINGS

Further advantages are evident from the following description of the drawings. Four exemplary embodiments of the invention are illustrated in the drawings. The drawings, the description and the claims contain numerous features in combination. The person skilled in the art will also consider the features individually in an expedient manner and combine said individual features to form expedient further combinations.

In which:

FIG. 1 a schematic illustration of a detection device in accordance with the invention, with a tracer unit,

FIG. 2 a detailed view of the tracer unit of the detection device in accordance with the invention,

FIG. 3 an alternative detection device with an alternative embodiment of a tracer unit,

FIG. 4 a further alternative detection device with an alternative embodiment of a tracer unit, and

FIG. 5 a schematic illustration of a further alternative detection device in accordance with the invention, with a tracer unit.

### DESCRIPTION OF THE EXEMPLARY EMBODIMENTS

FIG. 1 illustrates a detection device 10a in accordance with the invention for detecting at least one fault state, said detection device having at least one tracer unit 20a that comprises, in at least one operating state, a specifically added tracer substance 26a, and having a detection unit 12a for detecting a portion of material that has been released from the tracer substance 26a. The tracer unit 20a comprises a tracer element 22a on which the tracer substance 26a is arranged. The tracer unit 20a is embodied partially in one piece with an assembly element 34a of an assembly unit 30a and comprises a coating with the tracer substance 26a that is arranged on a surface of the assembly part 34a that is consequently embodied in one piece with the carrier element 22a. The tracer unit 20a is consequently embodied partially in one piece with the assembly unit 30a. The assembly unit 30a is embodied as an assembly element 32a that is embodied as a gas laser and is connected by way of an assembly element 34a that is embodied as a wire harness having a plurality of wires 42a (FIG. 2) to a further assembly unit 36a that comprises an assembly element 38a that is embodied as a voltage supply unit. The tracer substance 26a is applied as a coating to a wire insulation 40a of the assembly element 34a. The fault state that is detected using the detection device 10a is created by an inadmissible temperature change of the assembly unit 30a, wherein the inadmissible temperature change is given by the temperature exceeding a predetermined temperature limit below a damage-producing temperature of the at least one assembly unit 30a. The damage-producing temperature corresponds to a temperature at which the wire insulation 40a disintegrates. As a result of a vapor pressure of the tracer substance 26a, under normal operating conditions of the assembly unit 30a, some molecules of the tracer substance 26a pass from the coating into the gas phase and pass through an atmosphere to a detection element 14a that is especially designed for detecting the tracer substance 26a via an optical absorption measurement. Fundamentally, the detection element 14a can detect the tracer substance 26a by means of another method, by way of example by an electrical conductance value of metal-oxide sensors that has been changed by the tracer substance 26a. A concentration of the tracer substance 26a that can be achieved by means of the vapor pressure under normal operating conditions, wherein normal operating conditions correspond to operating conditions of a safe and reliable operating state of the assembly unit 30a, lies below a detection threshold of the detection element 14a. However, in the case of an inadmissible temperature increase, a greater portion of material of the tracer substance 26a evaporates from the coating and a resulting concentration of the tracer substance 26a at the detection element 14a exceeds the detection threshold so that the fault state is detected. The tracer substance 26a is especially selected for the purpose of experiencing an increase in the release rate in the event of an inadmissible temperature increase as the limit temperature is exceeded, so that in the event that the limit temperature is exceeded at least one percent more molecules per unit of time are released than under normal operating conditions. Fundamentally, a substance can also be selected as a tracer substance 26a that undergoes a reaction in the event of the limit temperature being exceeded and this reaction prevents molecules of the substance from passing into the gas phase or greatly reduces the probability of said molecules passing into the gas phase. The detection device 10a is operated in this case in an inverse mode to the otherwise conventional mode, in that a fault state is detected by means of detecting a substance that is at least greatly increased as a result of the fault state, and the detection unit 12a is provided in this variant for the purpose of detecting a reduction and/or an interruption in the release of the tracer substance 28a. The detection unit 12a further comprises a data interface 18a for transmitting a detected fault state to a superior monitoring system.

The tracer unit 20a comprises a specifically added further tracer substance 28a that on a further carrier element 48a that is embodied in one piece with a surface of the assembly element 38a of the assembly unit 36a. The tracer substance 26a and the further tracer substance 28a are consequently arranged on different assembly units 30a, 36a. Alternatively, said tracer substances can also be arranged by way of example on different assembly elements 32a, 34a of the assembly unit 30a. The further tracer substance 28a is designed for detecting the same fault state as the tracer substance 26a but a further tracer substance 28a can however also be selected for detecting a further fault state that is different from a fault state that is allocated to the tracer substance 26a. The detection unit 12a comprises a further detection element 16a that is designed especially for detecting a further tracer substance 28a. It is possible to determine the location of the fault state by means of the different detection elements 14a, 16a for the different tracer substances 26a, 28a, so that a fault source that is leading to the fault state can be found more rapidly. In a further alternative embodiment, the detector unit 12a can be provided for the purpose of detecting the at least one fault state by means of recognizing a pattern of signals of the tracer substance 26a and of the further tracer substance 28a, in place of detecting that an individual limit concentration has been exceeded.

Fundamentally, the tracer substance 26a and/or the further tracer substance 28a can also be selected especially for detecting that a temperature of an assembly unit 30a is below a temperature limit, whereby in particular an operation of the detection device 10a can be combined in the reverse mode. Furthermore, the tracer substance 26a and/or the further tracer substance 28a can also be provided for detecting a pressure increase in an assembly unit, by way of example at a gas line.

Three further exemplary embodiments of the invention are illustrated in FIGS. 3 to 5. The descriptions hereinunder and the drawings are limited essentially to the differences between the exemplary embodiments, wherein with respect to like designated assembly parts, in particular with regard to assembly parts that have like reference numbers, reference can also be made fundamentally to the drawings and/or the description of the other exemplary embodiments, in particular in FIGS. 1 to 2. In order to differentiate between the exemplary embodiments, the letter a is positioned after the reference numerals of the exemplary embodiment in FIGS. 1 to 2. In the exemplary embodiments in FIGS. 3 to 5, the letter a is replaced by the letters b to d.

FIG. 3 illustrates an alternative detection device 10b for detecting at least one fault state, said detection device having a tracer unit 20b that comprises, in at least one operating state, a specifically added tracer substance 26b, and having a detection unit 12b for detecting a portion of material that has been released from the tracer substance 26b. The tracer unit 20b comprises a carrier element 22b that is embodied in one piece with a wire insulation 40b of an assembly element 32b of an assembly unit 30b, said assembly element being embodied as a wire harness having a multiplicity of wires 42d. The carrier element 22b comprises an adsorbent material 24b that is formed from activated charcoal and the tracer substance 26b is adsorbed by said adsorbent material.

In a further alternative embodiment of a detection device 10c for detecting at least one fault state using a tracer unit 20c that comprises, in at least one operating state, a specifically added tracer substance 26c, and having a detection unit 12c for detecting a portion of material that has been released from the tracer substance 26c (FIG. 4), a carrier element 22c of the tracer unit 20c is embodied in one piece with a core of a wire 42c of an assembly element 32c of an assembly unit 30c, said assembly element being embodied as a wire harness. In the case of an inadmissible temperature increase of the assembly element 32c of the assembly unit 30c, a greater quantity of the tracer substance 26a in comparison to under normal operating conditions diffuses out of the wire 42c and through a wire insulation 40c of the assembly element 32c to the detection unit 12c in which a rise in a concentration of the tracer substance 26c is detected in a detection element 14c and consequently the fault state is detected.

FIG. 5 illustrates a further alternative embodiment of a detection device 10d for detecting at least one fault state, said detection device having a tracer unit 20d that comprises, in at least one operating state, a specifically added tracer substance 26d, and having a detection unit 12d for detecting a portion of material that has been released from the tracer substance 26d. The fault state that is detected by means of the detection device 10d is a pressure change that is produced by a pressure reduction. The tracer substance 26d is arranged in this case as a coating on a surface of a wall 46d that is consequently embodied in one piece with a carrier element 22d of the tracer unit 20d. The wall 46d forms an assembly unit 30d. The wall 46d defines a space 44d of a space capsule with respect to a surrounding vacuum in the case of a space flight. In the case of damage to the wall 46d, by way of example a tear, atmosphere escapes from the space 44d into the surrounding vacuum and a pressure reduction occurs. The escaping atmosphere causes a concentration of tracer substance 26d to reduce at a detection element 14d. The detection unit 12d that is operated in an inverse mode detects the fault state as soon as the concentration of the tracer substance 26d drops below a previously defined limit concentration that is selected so that when the concentration is below the limit concentration there is no risk to humans as a result of the lack of air. The detection unit 12d comprises a signal unit 50d that is provided for the purpose of signaling a detected fault state. The signal unit 50d is embodied as a warning light that is combined with a siren and outputs an acoustic signal and a visual signal in the case of a pressure reduction being detected and informs people who are present in the space 44d that a pressure reduction has been detected. The detection unit 12d comprises a data interface 18d by means of which a fault state that is detected by the detection device 10d is reported to a superior monitoring system and in which monitoring system the detected fault state is stored in a storage unit with additional information regarding the site and time a fault state occurs.

### REFERENCE NUMERALS

10 Detection Device
12 Detection Unit
14 Detection Element
16 Detection Element
18 Data Interface
20 Tracer Unit
22 Carrier Element
24 Adsorbent Material
26 Tracer Substance
28 Tracer Substance
30 Assembly Unit
32 Assembly Element
34 Assembly Element
36 Assembly Unit
38 Assembly Element
40 Wire Insulation
42 Wire
44 Space
46 Wall
48 Carrier Element
50 Signal Unit

1. A detection device for detecting at least one fault state, having comprising:
at least one tracer unit comprising: in at least one operating state,
at least one specifically added tracer substance (26a-d); and
at least one detection unit for detecting a portion of material that has been released from the at least one tracer substance.

2. The detection device according to claim 1, wherein
the at least one tracer unit comprises at least one carrier element, and
the at least one tracer substance is arranged at and/or in and/or on said carrier element.

3. The detection device according to claim 2, wherein
the at least one carrier element comprises at least one adsorbent material.

4. The detection device according to claim 1, wherein
the at least one tracer unit comprises at least one coating with the at least one tracer substance.

5. The detection device according to claim 1, wherein
the at least one tracer unit is embodied at least partially in one piece with at least one assembly unit.

6. The detection device according to claim 1, wherein
the at least one fault state is an inadmissible temperature change of at least one assembly unit.

7. The detection device according to claim 6, wherein the inadmissible temperature change is given by the temperature exceeding a predetermined temperature limit below a damage-producing temperature of the at least one assembly unit.

8. The detection device according to claim 1, wherein
the at least one fault state is a pressure change.

9. The detection device according to claim 1, wherein
the at least one tracer unit comprises, in at least one operating state, at least one specifically added further tracer substance.

10. The detection device according to claim 9, wherein
the at least one tracer substance and the at least one further tracer substance are arranged at least to a great extent at and/or on different assembly units and/or different assembly elements of at least one assembly unit.

11. The detection device at least according to claim 9, wherein
the at least one detection unit is provided for the purpose of detecting the at least one fault state by means of recognizing a pattern of signals of the at least one tracer substance and the at least one further tracer substance.

12. The detection device according to claim 1, wherein
the at least one detection unit is provided for the purpose of detecting a reduction and/or an interruption in the release of the at least one tracer substance.

13. The detection device according to claim 1, wherein
the at least one detection unit comprises at least one data interface that is provided for transmitting a detected fault state to a superior monitoring system.

14. The detection device according to claim 1, wherein the at least one detection unit comprises at least one signal unit that is provided for the purpose of signaling a detected fault state.

15. A method for detecting a fault state, with a detection device according to claim 1.

16. The detection device according to claim 2, wherein
the at least one tracer unit comprises at least one coating with the at least one tracer substance.

17. The detection device according to claim 2, wherein
the at least one tracer unit is embodied at least partially in one piece with at least one assembly unit.

18. The detection device according to claim 2, wherein
the at least one fault state is an inadmissible temperature change of at least one assembly unit.

19. The detection device according to claim 2, wherein
the at least one fault state is a pressure change.

20. The detection device according to claim 2, wherein
the at least one tracer unit comprises, in at least one operating state, at least one specifically added further tracer substance.
